(19) United States
(12) Patent Application Publication
(10) Pub. No.: US 2011/0311854 A1
(43) Pub. Date: Dec. 22, 2011

(54) Electrochemical Cell Electrode With Sandwich Cathode And Method For Making Same

(75) Inventors: Esther S. Takeuchi, East Amherst, NY (US); Hong Gan, Williamsville, NY (US)

(73) Assignee: Greatbatch Ltd., Clarence, NY (US)

(21) Appl. No.: 11/768,973

(22) Filed: Jun. 27, 2007

Related U.S. Application Data
(60) Provisional application No. 60/883,202, filed on Jan. 3, 2007.

(51) Int. Cl. H01M 2/14; H01M 6/14

(52) U.S. Cl. 429/129; 29/623.5

(57) ABSTRACT

An electrochemical cell comprising an anode, and a cathode of a first cathode active material contacted to a first side of a current collector and a second cathode active material contacted to a second side of the current collector thereby forming an elongated cathode sheet. The first cathode active material has a first energy density and first rate capability, and the second cathode active material has a second energy density and a second rate capability. The first energy density of the first material is less than the second energy density of the second material, while the first rate capability of the first material is greater than the second rate capability of the second material. The elongated cathode sheet is folded onto itself to form a sandwich cathode having the configuration of: first cathode active material/current collector/second cathode active material/second cathode active material/current collector/first cathode active material.

### CROSS-REFERENCE TO RELATED APPLICATION

This application claims priority from U.S. Provisional Application Ser. No. 60/883,202, filed Jan. 3, 2007.

### BACKGROUND OF THE INVENTION

1. Field of the Invention

This invention relates to the conversion of chemical energy to electrical energy. In particular, the present invention relates to a method of fabricating a sandwich cathode for an electrochemical cell. The sandwich cathode includes a second cathode active material of a relatively high energy density but of a relatively low rate capability sandwiched between two current collectors and with a first cathode active material having a relatively low energy density but of a relatively high rate capability in contact with the opposite sides of the current collectors. The sandwich cathode design is useful in electrochemical cells that power an implantable medical device requiring a high rate discharge application. The method of fabricating the sandwich cathode enables efficient and low cost manufacturing of the electrochemical cell in which it is used.

2. Description of Related Art

Improvements in implantable cardiac defibrillators and the electrochemical cells that power them have enabled the use of a single cell to power a defibrillator. The requisite electrochemical cell must have both a high overall energy density and a high rate capability. The capacity of the electrochemical cell is not only dependent on the electrode assembly design and packing efficiency, it also is dependent on the type of active materials used.

Heretofore, a number of patents have disclosed electrodes that provide a cell having both a high overall energy density and a high rate capability and methods for fabrication of them.

For example, U.S. Pat. No. 5,744,258 to Bai et al., issued Apr. 28, 1998, discloses a hybrid electrode for a high power, high energy, electrical storage device. The electrode contains both a high-energy electrode material and a high-rate electrode material. The two materials are deposited on a current collector, and the electrode is used to make an energy storage device that exhibits both the high-rate capability of a capacitor and the high energy capability of a battery. The two materials can be co-deposited on the current collector in a variety of ways, either in superimposed layers, adjacent layers, intermixed with each other or one material coating the other to form a mixture that is then deposited on the current collector.

U.S. Pat. No. 6,551,747 to Gan, which is assigned to the assignee of the present invention and incorporated herein by reference, describes a sandwich cathode design having a second cathode active material of a relatively high energy density but of a relatively low rate capability sandwiched between two current collectors and with a first cathode active material having a relatively low energy density but of a relatively high rate capability in contact with the opposite sides of the current collectors. A preferred low energy density/high rate capability material is silver vanadium oxide (SVO), and a preferred high energy density/low rate capability cathode active material is fluorinated carbon (CFₓ). The cathode design is useful for powering an implantable medical device requiring a high rate discharge application.

Additionally, U.S. Pat. No. 6,743,547 to Gan et al., which is also assigned to the assignee of the present invention and incorporated herein by reference, describes a process for making the sandwich cathode of the '747 patent to Gan. In an electrode having the configuration first active material/current collector/second active material, one of the electrode active materials is in a cohesive form of active particles being firmly held together as part of the same mass, and is thus incapable of moving through the current collector perforations to the other side thereof. However, in an un-cohesive form of active particles not being firmly held together as part of a mass, the one electrode active material is capable of communication through the current collector perforations. The other or second active material is in a form incapable of communication through the current collector, whether it is in a cohesive or un-cohesive powder form. The assembly of first active material/current collector/second active material may thus be pressed from either the direction of the first electrode active material to the second electrode active material, or visa versa.

Additionally, U.S. Pat. No. 6,790,561 to Gan et al., which is also assigned to the assignee of the present invention and incorporated herein by reference, describes a process for fabricating continuously coated electrodes on a porous current collector and cell designs incorporating the resulting electrodes. An electrochemical cell is comprised of at least one electrode that is produced by coating a slurry mixture of an active material, possibly a conductive additive, and a binder dispersed in a solvent and contacted to a perforated current collector. After volatilizing the solvent, a second, different active material is coated to the opposite side of the current collector, either as a slurry, a pressed powder, a pellet or a free standing sheet. One example of an electrode in accordance with the invention is a cathode having a configuration of SVO/current collector/CFₓ.

It is generally recognized that for lithium cells, silver vanadium oxide (SVO) and, in particular, ε-phase silver vanadium oxide (AgV₂O_{5.5}), is preferred as the cathode active material in a high rate, high energy density cell. This active material has a theoretical volumetric capacity of 1.37 Ah/ml. By comparison, the theoretical volumetric capacity of CFₓ material (x=1.1) is 2.42 Ah/ml, which is 1.77 times that of ε-phase silver vanadium oxide. However, for powering a cardiac defibrillator, SVO is preferred because it can deliver high current pulses or high energy within a relatively short period of time. Although CFₓ has higher volumetric capacity, it cannot generally be used in medical devices requiring a high rate discharge application due to its low to medium rate of discharge capability.

Additionally, a method of providing an active material in a sheet form is described in U.S. Pat. Nos. 5,435,874 and 5,571,640, both to Takeuchi et al. Both patents are assigned to the assignee of the present invention and incorporated herein by reference. These patents teach taking ground cathode active starting materials mixed with conductive diluents and a suitable binder material, and suspending the admixture in a solvent to form a paste. The admixture paste is fed into rollers to form briquettes or pellets, and then fed to rolling mills to produce the cathode active material in a sheet tape form. The sheet is finally dried and punched into blanks or plates of a desired shape.

While the methods for constructing a cell electrode having disparate active materials contacted to opposite sides of a current collector taught by the previously discussed prior art patents are viable, there remains a need for improved methods of making the sandwich cathodes in a more efficient manner. Any new process needs to be adaptable to configurations that enable even more efficient and lower cost manufacturing of the overall electrochemical cells. The present invention teaches new methods of making electrodes, especially ones having different active materials contacted to opposite sides of a current collector and that are readily adaptable to efficient manufacturing techniques.

### SUMMARY OF THE INVENTION

Accordingly, embodiments of the present invention are provided that meet at least one of the following objects.

It is an object of this invention to provide an electrochemical cell including a sandwich electrode that is simple to manufacture.

It is a further object to provide a low-cost and simple method for making a sandwich cathode.

According to the present invention, therefore, an electrochemical cell is provided comprising an anode, a cathode of a first cathode active material contacted to a first side of a perforated current collector and a second cathode active material contacted to the second side of the perforated current collector, thereby forming an elongated cathode sheet, and an electrolyte activating the anode and the cathode. The first cathode active material is of a first energy density and a first rate capability and the second cathode active material is of a second energy density and a second rate capability, the first energy density of the first cathode active material being less than the second energy density of the second cathode active material while the first rate capability of the first cathode active material is greater than the second rate capability of the second cathode active material. The elongated cathode sheet is then folded onto itself to form a sandwich cathode having the configuration: first cathode active material/current collector/second cathode active material/current collector/first cathode active material.

The anode may be of an alkali metal, preferably lithium metal, and the electrolyte may be a nonaqueous electrolyte. The first cathode active material may be selected from the group consisting of CFₓ, Ag₂O, Ag₂O₂, CuF, Ag₂CrO₄, MnO₂, SVO, and mixtures thereof. The second cathode active material may be selected from the group consisting of SVO, CSVO, V₂O₅, MnO₂, LiCoO₂, LiNiO₂, LiMnO₂, CuO₂, TiS, Cu₂S, FeS, FeS₂, copper oxide, copper vanadium oxide, and mixtures thereof. In one preferred embodiment, the first cathode active material is SVO and the second cathode active material is CFₓ, such that the sandwich cathode has the configuration: SVO/current collector/CFₓ/current collector/SVO.

The current collector may be formed from a material selected from the group consisting of stainless steel, titanium, tantalum, platinum, gold, aluminum, cobalt nickel alloys, nickel-containing alloys, highly alloyed ferritic stainless steel containing molybdenum and chromium, and nickel-, chromium- and molybdenum-containing alloys. In one embodiment, the current collector is titanium having a coating selected from the group consisting of graphite/carbon material, iridium, iridium oxide and platinum provided thereon.

The elongated cathode sheet may be prepared by contacting pre-formed tapes or dispensed paste tapes of the first and second cathode active materials to the opposite sides of the current collector. In one preferred embodiment, the elongated cathode sheet is prepared by simultaneously contacting and compressing tapes of the first cathode active material to the first side of the current collector and the second cathode active material to the second side of the current collector.

Also according to the present invention, a method of manufacturing an electrode for an electrochemical cell is provided. The method comprises the steps of: delivering an elongated current collector strip through a tape contacting station, contacting a tape of a first electrode active material to the first side of the elongated current collector strip, contacting a tape of a second electrode active material to the second side of the elongated current collector strip to form a coated electrode strip, cutting a section of the coated electrode strip to form an elongated electrode sheet; and folding the elongated electrode sheet onto itself to form a sandwich electrode with the second electrode active material facing inwardly and the first electrode active material facing outwardly. For cells which have irregular (i.e. non-rectangular) shapes, the method may further comprise the step of cutting the sandwich electrode into a pattern of matched electrode plate units.

The method may include the steps of compressing the tape of first electrode active material onto the current collector and compressing the tape of second electrode active material onto the opposite side of the current collector. These steps are preferably performed simultaneously and preferably by a pair of opposed rollers.

Also according to the present invention, a method of providing an electrochemical cell is provided, comprising the steps of: providing an anode, providing a cathode as recited for the above method of manufacturing an electrode, disposing a separator between the anode and the cathode, and activating the anode and the cathode with an electrolyte.

The foregoing and additional objects, advantages, and characterizing features of the present invention will become increasingly more apparent upon a reading of the following detailed description together with the included drawings.

### BRIEF DESCRIPTION OF THE DRAWINGS

The present invention will be described by reference to the following drawings, in which like numerals refer to like elements, and in which:

FIG. 1 is a side elevation, cross-sectional view of a tape of a first cathode active material being brought into contact with a first side of an elongated strip of a perforated current collector;

FIG. 2 is a side cross-sectional view of the first cathode active material being compressed onto the first side of the perforated current collector screen by the action of two rollers forming a nip there between;

FIG. 3 is a side cross-sectional view of a second cathode active material being compressed onto a second side of the perforated current collector by the action of two rollers;

FIGS. 4 and 5 are side cross-sectional views of the first and second cathode active materials being compressed onto the first and second sides of a perforated current collector by the action of two opposed pressing plates;

FIG. 6 is a side cross-sectional view of pre-formed tapes of the first and second cathode active materials being compressed onto the first and second sides of a perforated current collector screen by the action of two rollers;

FIG. 7 is a side cross-sectional view of dispensed paste ribbons of the first and second cathode active materials being compressed onto the first and second sides of a perforated current collector screen by the action of two rollers;

FIG. 8 is an illustration of a portion of an elongated cathode sheet of the present invention, further depicting a cutout pattern for one embodiment of a cell cathode;

FIG. 9 is an illustration of the cell cathode made from the cutout pattern of FIG. 8, but prior to winding into a jellyroll configuration;

FIG. 10A is a side elevation view of the cathode of FIG. 9 after winding into a jellyroll configuration;

FIG. 10B is a top view of the cathode of FIG. 10A, taken along the line 10B-10B of FIG. 10A; and

FIG. 11 is a side cross-sectional view of an electrode comprising first and second electrode active materials being folded over onto itself to form a sandwich electrode with the second electrode active material facing inwardly and the first electrode active material facing outwardly.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DETAILED DESCRIPTION OF THE PREFERRED EMBODIMENTS

As used herein, the term “tape” is meant to indicate an elongated, thin cohesive strip of material, and typically including electrode active material. The terms “ribbon” and “tape” may be used interchangeably herein, although the use of the term “tape” is not meant to indicate that an adhesive material or surface layer must be present in the structure.

Electrochemical cells made by methods of the present invention is preferably of a primary chemistry and possess sufficient energy density and discharge capacity required to meet the vigorous requirements of implantable medical devices. Such a cell typically comprises an anode of a metal selected from Groups IA, IIA and IIIB of the Periodic Table of the Elements. Anode active materials include lithium, sodium, potassium, etc., and their alloys and intermetallic compounds including, for example, Li—Si, Li—Al, Li—B and Li—Si—B alloys and intermetallic compounds. The preferred anode comprises lithium. An alternate anode comprises a lithium alloy such as a lithium-aluminum alloy. The greater the amounts of aluminum present by weight in the alloy, however, the lower the energy density of the cell.

For a primary cell, the anode is a thin metal sheet or foil of the lithium material, pressed or rolled on a metallic anode current collector, i.e., preferably comprising titanium, titanium alloy, or nickel. Copper, tungsten and tantalum are also suitable materials for the anode current collector. The anode has an extended tab or lead contacted by a weld to a cell case of conductive material in a case-negative electrical configuration. Alternatively, the negative electrode may be formed in some other geometry, such as a bobbin shape, cylinder or pellet to allow an alternate low surface cell design.

The electrochemical cell further comprises a cathode of electrically conductive material that serves as the other cell electrode. The cathode is preferably of solid materials and the electrochemical reaction at the cathode involves conversion of ions that migrate from the anode to the cathode into atomic or molecular forms. The solid cathode may comprise a first active material of a metal element, a metal oxide, a mixed metal oxide and a metal sulfide, and combinations thereof and a second active material of a carbonaceous chemistry. The metal oxide, the mixed metal oxide and the metal sulfide of the first active material has a relatively lower energy density but a relatively higher rate capability than the second active material.

The first active material is formed by the chemical addition, reaction, or otherwise intimate contact of various metal oxides, metal sulfides and/or metal elements, preferably during thermal treatment, sol-gel formation, chemical vapor deposition or hydrothermal synthesis in mixed states. The active materials thereby produced contain metals, oxides and sulfides of Groups, IB, IIB, IIIB, IVB, VB, VIIB, VIIB and VIII, which includes the noble metals and/or other oxide and sulfide compounds. A preferred cathode active material is a reaction product of at least silver and vanadium.

One preferred mixed metal oxide is a transition metal oxide having the general formula SMₓV₂O_{y} where SM is a metal selected from Groups IB to VIIB and VIII of the Periodic Table of Elements, wherein x is about 0.30 to 2.0 and y is about 4.5 to 6.0 in the general formula. By way of illustration, and in no way intended to be limiting, one exemplary cathode active material comprises silver vanadium oxide having the general formula AgₓV₂O_{y} in any one of its many phases, i.e., β-phase silver vanadium oxide having in the general formula x=0.35 and y 5.8, γ-phase silver vanadium oxide having in the general formula x=0.80 and y=5.40 and ε-phase silver vanadium oxide having in the general formula x=1.0 and y=5.5, and combination and mixtures of phases thereof. For a more detailed description of such cathode active materials, reference is made to U.S. Pat. No. 4,310,609 to Liang et al., which is assigned to the assignee of the present invention and incorporated herein by reference.

Another preferred composite transition metal oxide cathode material includes V₂O_{z} wherein z≦5 combined with Ag₂O with silver in either the silver(II), silver(I) or silver(0) oxidation state and CuO with copper in either the copper(II), copper(I) or copper(0) oxidation state to provide the mixed metal oxide having the general formula CuₓAg_{y}V₂O_{z}, (CSVO). Thus, the composite cathode active material may be described as a metal oxide-metal oxide-metal oxide, a metal-metal oxide-metal oxide, or a metal-metal-metal oxide and the range of material compositions found for CuₓAg_{y}V₂O_{z} is preferably about 0.01≦z≦6.5. Typical forms of CSVO are Cu_{0.16}Ag_{0.67}V₂O_{z} with z being about 5.5 and Cu_{0.5}Ag_{0.5}V₂O_{z} with z being about 5.75. The oxygen content is designated by z since the exact stoichiometric proportion of oxygen in CSVO can vary depending on whether the cathode material is prepared in an oxidizing atmosphere such as air or oxygen, or in an inert atmosphere such as argon, nitrogen and helium. For a more detailed description of this cathode active material reference is made to U.S. Pat. Nos. 5,472,810 to Takeuchi et al. and 5,516,340 to Takeuchi et al., both of which are assigned to the assignee of the present invention and incorporated herein by reference.

The second active material is preferably a carbonaceous compound prepared from carbon and fluorine, which includes graphitic and nongraphitic forms of carbon, such as coke, charcoal or activated carbon. Fluorinated carbon is represented by the formula (CFₓ)ₙ wherein x varies between about 0.1 to 1.9 and preferably between about 0.5 and 1.2, and (C₂F)ₙ wherein the n refers to the number of monomer units which can vary widely.

In a broader sense, it is contemplated by the scope of the present invention that the first active material is one which has a relatively lower energy density but a relatively higher rate capability than the second active material. In addition to silver vanadium oxide and copper silver vanadium oxide, V₂O₅, MnO₂, LiCoO₂, LiNiO₂, LiMn₂O₄, TiS₂, Cu₂S, FeS, FeS₂, copper oxide, copper vanadium oxide, and mixtures thereof are useful as the first active material, and in addition to fluorinated carbon, Ag₂O, Ag₂O₂, CuF₂, Ag₂CrO₄, MnO₂ and even SVO itself are useful as the second active material. Further details on densities and capacities of these materials may be found at columns 4 and 5 of the aforementioned U.S. Pat. No. 6,551,747.

Before fabrication into a sandwich electrode for incorporation into an electrochemical cell, the first and second cathode active materials prepared as described above are preferably mixed with a binder material and a conductive diluent. The selection of the particular binder material and conductive diluent, as well as the relative proportions thereof will depend upon the particular processes used to apply the cathode active materials to the opposite sides of the current collector.

A suitable binder material is preferably a thermoplastic polymeric material. The term thermoplastic polymeric material is used in its broad sense and any polymeric material which is inert in the cell and which passes through a thermoplastic state, whether or not it finally sets or cures, is included within the term “thermoplastic polymer”. Representative binder materials include polyethylene, polypropylene, polyimide, and fluoropolymers such as fluorinated ethylene, fluorinated propylene, polyvinylidene fluoride (PVDF), and polytetrafluoroethylene (PTFE). Natural rubbers are also useful as the binder material with the present invention.

Suitable conductive diluents include acetylene black, carbon black and/or graphite. Metals such as nickel, aluminum, titanium and stainless steel in powder form are also useful as conductive diluents.

A typical electrode for a nonaqueous, lithium electrochemical cell is made from a mixture of 80 to 95 weight percent of an electrode active material, 1 to 10 weight percent of a conductive diluent and 3 to 10 weight percent of a polymeric binder. Less than 3 weight percent of the binder provides insufficient cohesiveness to the loosely agglomerated electrode active materials to prevent delamination, sloughing and cracking during electrode preparation and cell fabrication and during cell discharge. More than 10 weight percent of the binder provides a cell with diminished capacity and reduced current density due to lowered electrode active density.

Current collectors in the present invention may be formed of a metal selected from the group consisting of stainless steel, titanium, tantalum, platinum, gold, aluminum, cobalt nickel alloys, nickel-containing alloys, highly alloyed ferritic stainless steel containing molybdenum and chromium, and nickel-, chromium- and molybdenum-containing alloys. The preferred current collector material is titanium, and most preferably the titanium cathode current collector has a thin layer of graphite/carbon material, iridium, iridium oxide or platinum applied thereto. Cathodes prepared as described above may be in the form of one or more plates operatively associated with at least one or more plates of anode material, or in the form of a strip wound with a corresponding strip of anode material in a structure similar to a “jellyroll”.

In embodiments of the invention in which the active materials are applied in a cohesive form, i.e. as a solid tape, sheet, or a pellet that is compressed against the current collector, a particular active material may be mixed with a binder such as a powdered fluoro-polymer, more preferably powdered polytetrafluoroethylene or powdered polyvinylidene fluoride present at about 1 to about 5 weight percent of the cathode mixture. Further, up to about 10 weight percent of a conductive diluent is preferably added to the cathode mixture to improve conductivity. Suitable materials for this purpose include acetylene black, carbon black and/or graphite or a metallic powder such as powdered nickel, aluminum, titanium and stainless steel. The preferred cathode active mixture thus includes a powdered fluoro-polymer binder present at about 3 weight percent, a conductive diluent present at about 3 weight percent and about 94 weight percent of the cathode active material.

A preferred first cathode active material having a greater rate capability, but a lesser energy density is of a mixed metal oxide such as SVO or CSVO. This material is typically provided in a formulation of, by weight, about 94% SVO and/or CSVO, 3% binder and 3% conductive diluent as the formulation facing the anode. The second active material in contact with the other side of the current collector is, for example, CFₓ. This material is preferably provided in a second active formulation having, by weight, about 91% CFₓ, 5% binder and 4% conductive diluent.

In embodiments of the invention in which the active materials are delivered in the form of a paste or slurry applied to the current collector, a particular active material may also be mixed with a binder and, if desired, a conductive diluent to promote conductivity. The slurry is provided by dissolving or dispersing the electrode active material, conductive diluent and binder in a solvent. Suitable solvents include water, methyl ethyl ketone, cyclohexanone, isophorone, N-methyl-2-pyrrolidone (NMP), N,N-dimethylformamide, N,N-dimethylacetamide, toluene, and mixtures thereof.

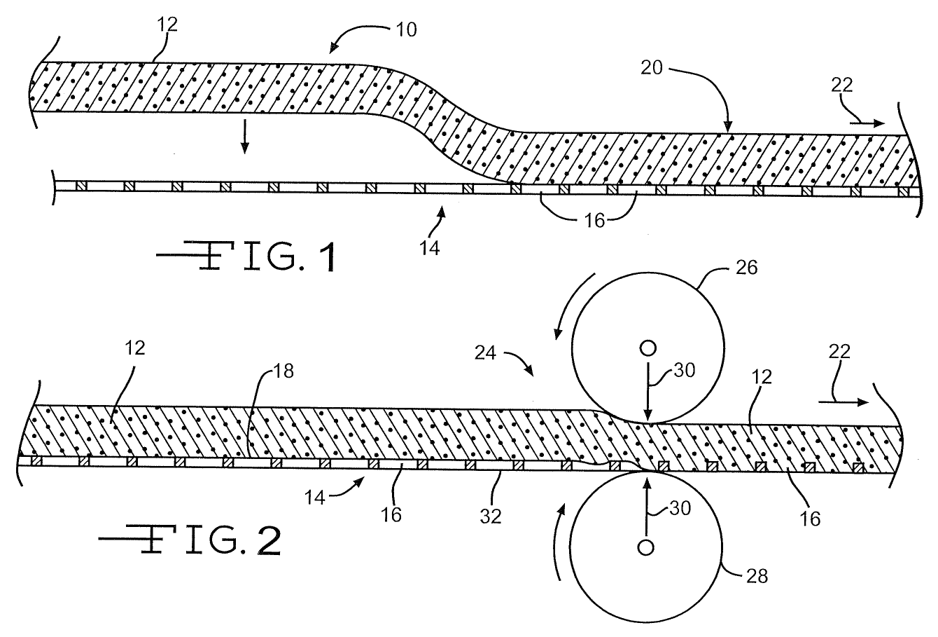

Referring now to the drawings, FIG. 1 is a side elevation cross-sectional view of a tape 10 of a first cathode active material 12 being brought into contact with a first side of an elongated current collector 14 provided with perforations or openings 16. The tape 10 containing the first cathode active material 12 is contacted to a first side 18 of the perforated current collector 14 by a continuous process operated for a period of time. This produces an elongated cathode sheet 20 for further processing into a sandwich cathode. Tape 10 and the current collector 14 are thus provided in motion at equal velocities as indicated by arrow 22.

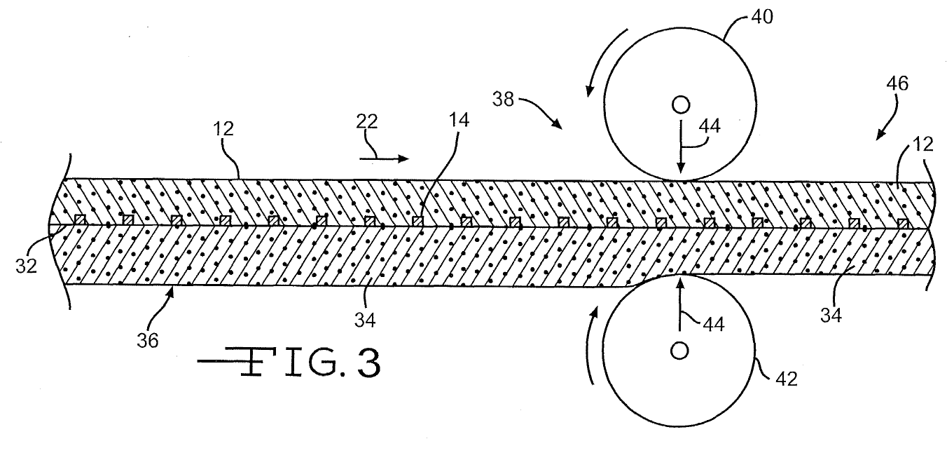

FIG. 2 is a side cross-sectional view of the first cathode active material 12 being compressed onto the first side 18 of the elongated perforated current collector 14 by the action of two opposed rollers forming a nip there between. Tape 10 of the first cathode active material 12 contacted to the perforated current collector 14 is compressed at a first tape contacting station 24 by opposed rollers 26 and 28. As indicated by arrows 30, rollers 26 and 28 apply opposed compressive forces to tape 10. The compressive forces may be sufficient to extrude the compressed cathode active material 12 through the current collector openings or perforations 16 to a point where the active material is coplanar with the second surface 32 of the current collector 14. These forces may also result in the compressed cathode active material 12 having a lesser thickness and a higher density. In one embodiment, the density of the compressed cathode active material 12 may be as much as about 50 percent greater than when it is in the uncompressed state. In another embodiment, compression of the active tape 10 may be negligible, with the function of the opposed rollers being to attain good electrical contact between the cathode active material 12 and the current collector 14.

FIG. 3 is a side cross-sectional view of a second cathode active material 34 being compressed onto the second side 32 of the elongated current collector 14. The tape 36 of the second cathode active material 34 is contacted to the second surface 32 of the perforated current collector 14. In a manner similar to the tape 10 of the first cathode active material 12 shown in FIG. 1, the second cathode active material 34 is then compressed at a second contacting station 38 by opposed rollers 40 and 42 as indicated by arrows 44.

An elongated cathode sheet 46 comprised of the first cathode active material 12 and the second cathode active material 34 contacted to the opposed sides of the current collector 14 is thus formed. Elongated cathode sheet 46 may be wound onto a driven receiving roll (not shown) for delivery to subsequent cathode fabrication process stations, or fed directly to an electrode cutting station (not shown).

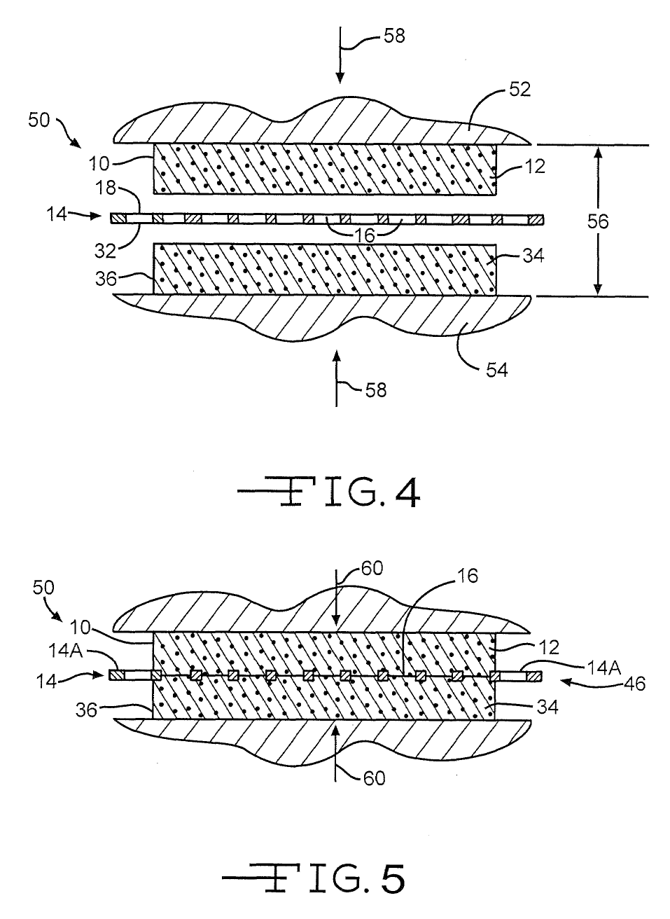

FIGS. 4 and 5 are side cross-sectional views of an alternative embodiment in which the tapes of the first and second cathode active materials 12, 34 are compressed onto the first and second sides 18, 32 of the perforated current collector 14 by the action of two opposed pressing plates. It is first noted that the direction of view of FIGS. 4 and 5 is orthogonal to that of FIGS. 1 to 3. The view of FIGS. 4 and 5 is along the cathode material ribbons 10 and 36 in the direction of their motion, while the view of FIGS. 1 to 3 is across the tapes 10 and 36 perpendicular to the direction of their motion.

Tape contacting station 50 is comprised of opposed first and second press plates 52 and 54. In the operation of tape contacting station 50, the first tape 10 of first cathode active material 12, the second tape 36 of second cathode active material 81 and the elongated current collector 14 are delivered into gap 56 between plates 52 and 54. The motion of tapes 10, 36 and current collector strip 14 is intermittent and synchronized. A length of tapes 10, 36 and current collector 14 that is equal to the length of press plates 52 and 54 (in the direction of tape/strip motion) is delivered through gap 56, and then the tape/strip motion is stopped. Plates 52 and 54 are then moved toward each other as indicated by opposed arrows 58 by hydraulic cylinders or other suitable high-force linear actuating means. As indicated by arrows 60, tapes 10 and 36 are compressed against the current collector 14 and against each other through the perforations 16.

Opposed press plates 52 and 54 are then retracted outwardly from the piece of elongated cathode sheet 46. Any excess current collector material 14A extending beyond the compressed first and second cathode materials 12, 34 may be trimmed in subsequent electrode processing operations. The indexing motion of the active tapes 10, 36 and the current collector strip 14 is resumed, and another section of cathode tape and current collector is delivered into gap 56. It is noted that the tape/strip length that is indexed through gap 56 may be slightly less than the press plate length in the direction of tape/strip motion, resulting in a slight overlap of the compressed portions. This is done to allow for process operating tolerances, thereby ensuring that the entire area of cathode active tapes 10 and 36 is compressed by plates 52 and 54 onto current collector 14.

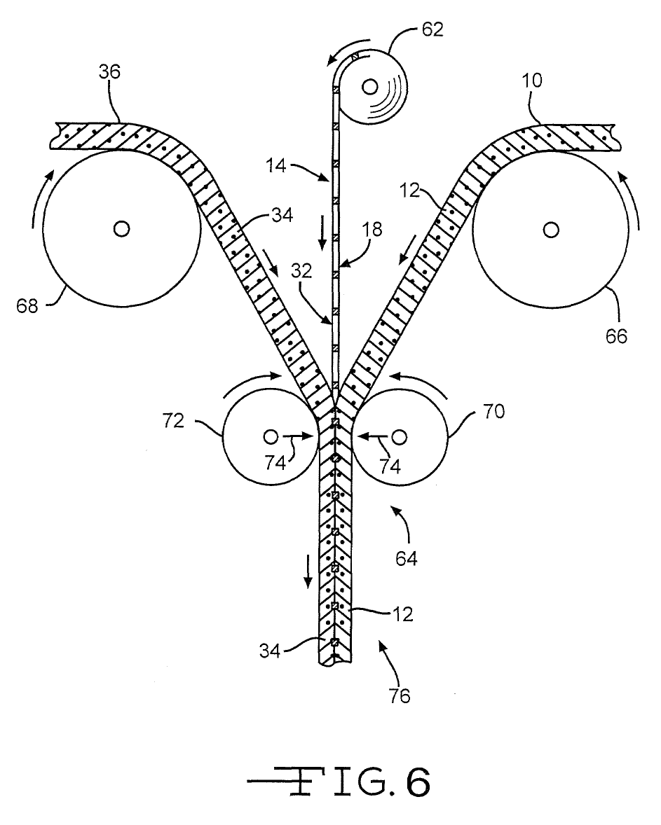

FIG. 6 is a side cross-sectional view of pre-formed tapes 10, 36 of the first and second cathode active materials 12, 34 being continuously and simultaneously compressed onto the first and second sides 18, 32 of an elongated perforated current collector 14 by the action of two rollers. Prior to the cathode sheet forming process depicted in FIG. 6, pre-formed tapes 10 and 36 of the first and second cathode active materials 12, 34 may be made according to the methods described in the aforementioned U.S. Pat. Nos. 5,435,874 and 5,571,640, both to Takeuchi et al., and wound upon supply rolls (not shown).

Elongated current collector strip 14 is unwound from roll 62 and delivered to tape contacting station 64. Simultaneously, a pre-formed tape 10 of the first cathode active material 12 and a pre-formed tape 36 of the second cathode active material 34 are unwound from their respective supply rolls (not shown) and guided by guide rollers 66 and 68 to the tape contacting station 64. The pre-formed active tapes 10 and 36 are simultaneously contacted and compressed 74 onto the elongated current collector 14 by the opposed rollers 70 and 72. The resulting elongated cathode sheet 76 comprised of first cathode active material 12 and the second cathode active material 34 contacted/compressed onto opposed sides of the current collector 14 is thus formed. Elongated cathode sheet 76 may be wound onto a driven receiving roll (not shown) for delivery to subsequent cathode fabrication process stations.

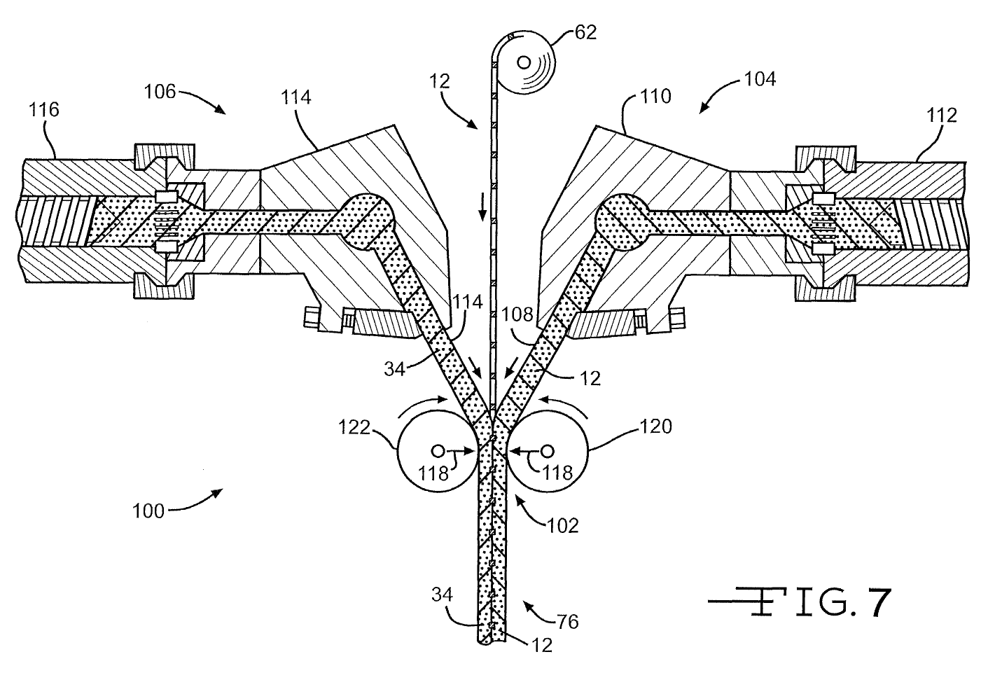

In another embodiment, one or both of the first and second tapes 10, 36 of the cathode active materials 12, 34 may be provided as a ribbon of paste, and dispensed and delivered to the tape contacting station. FIG. 7 is a side cross-sectional view of dispensed paste ribbons of the first and second cathode active materials 12, 34 being compressed onto the first and second sides 18, 32 of the elongated perforated current collector 14 by the action of two rollers. Cathode sheet forming apparatus 100 is comprised of ribbon contacting station 102, a first paste dispenser 104, and a second paste dispenser 106.

Paste ribbon 108 containing the first cathode active material 12 is dispensed from the first dispenser 104, which is comprised of an extrusion die 110 and a screw extruder 112. Simultaneously, the paste ribbon 114 containing the second cathode active material 34 is dispensed from the second dispenser 106, which is comprised of an extrusion die 114 and a screw extruder 116. The elongated current collector 14 is unwound from roll 62, and delivered through ribbon contacting station 102. Simultaneously, the paste ribbons 108 and 114 are contacted and compressed 118 onto the elongated current collector 14 by the opposed rollers 120 and 122, thereby forming the elongated cathode sheet 76.

Paste dispensers 104 and 106 are meant to be exemplary and not limiting with respect to the manner in which the active pastes are provided to the ribbon contacting station 102. It will be apparent to those skilled in the art that many other suitable devices may be provided that dispense a moving sheet of an active paste material having an adjustable width and thickness at an adjustable delivery speed. Suitable devices may include fixed lip slot dies, slide dies, blade coaters, and curtain coaters. Other pumping devices may be used instead of a screw extruder, such as a gear pump, or a progressing cavity pump.

Compositions of suitable paste of cathode active materials, including binder polymers, conductive diluents, and solvents are disclosed in the aforementioned U.S. Pat. No. 6,790,561 of Gan et al. In general, it is preferable that a cathode material paste be a highly viscous, non-Newtonian fluid that remains substantially rigid when the applied shear stress is less than a given stress threshold (yield stress), but that flows approximately like a Newtonian fluid when the applied shear stress exceeds the threshold. Such a fluid is generally known as a Bingham plastic.

In addition to the paste dispensers 104 and 106, the cathode sheet forming apparatus 100 may further comprise one or more dryers (not shown) for evaporating solvent from the cathode paste ribbons 108 and 114. Separate paste dryers may be provided between paste dispensers 104, 106 and the ribbon contacting station 102, or a single dryer may be provided downstream of the ribbon contacting station 102. In the event that the cathode paste ribbons 108 and 114 are still in a tacky state when they are compressed at contacting station 102, rollers 120 and 122 may be provided with a low surface energy coating such as polytetrafluoroethylene (PTFE), or other similar fluoropolymer to prevent paste adhesion thereto.

It is also noted that in the depiction of the methods and apparatus for preparing an elongated electrode sheet shown in FIGS. 1 to 7, the size of the various rollers and the paste dispensing apparatus are not drawn to scale with respect to the relative thicknesses of the cathode ribbons and the current collector strip. The rollers and dispensing apparatus are comparatively larger, and are sized as shown for simplicity of illustration.

In forming the elongated cathode sheets 46, 76 by the apparatus and method depicted in FIGS. 1 to 7, the first cathode active material 12 is of a first energy density and a first rate capability and the second cathode active material 34 is of a second energy density and a second rate capability, the first energy density of the first cathode active material being less than the second energy density of the second cathode active material while the first rate capability of the first cathode active material is greater than the second rate capability of the second cathode active material. In one preferred embodiment, the first cathode active material is SVO and the second cathode active material is CFₓ, such that the elongated cathode sheets 46, 76 have the configuration SVO/current collector/CFₓ.

The elongated cathode sheets 46, 76 of FIGS. 3 and 5 to 7 may be subsequently cut into a variety of shapes for use in electrochemical cells. Single plates may be cut from the sheets 46, 76, as well as dual plates in a “butterfly” configuration as described in U.S. Pat. No. 5,250,373 to Muffoletto et al., which is assigned to the assignee of the present invention and incorporated herein by reference. Elongated patterns may also be cut with repeating units for use in “jellyroll” or serpentine electrode configurations.

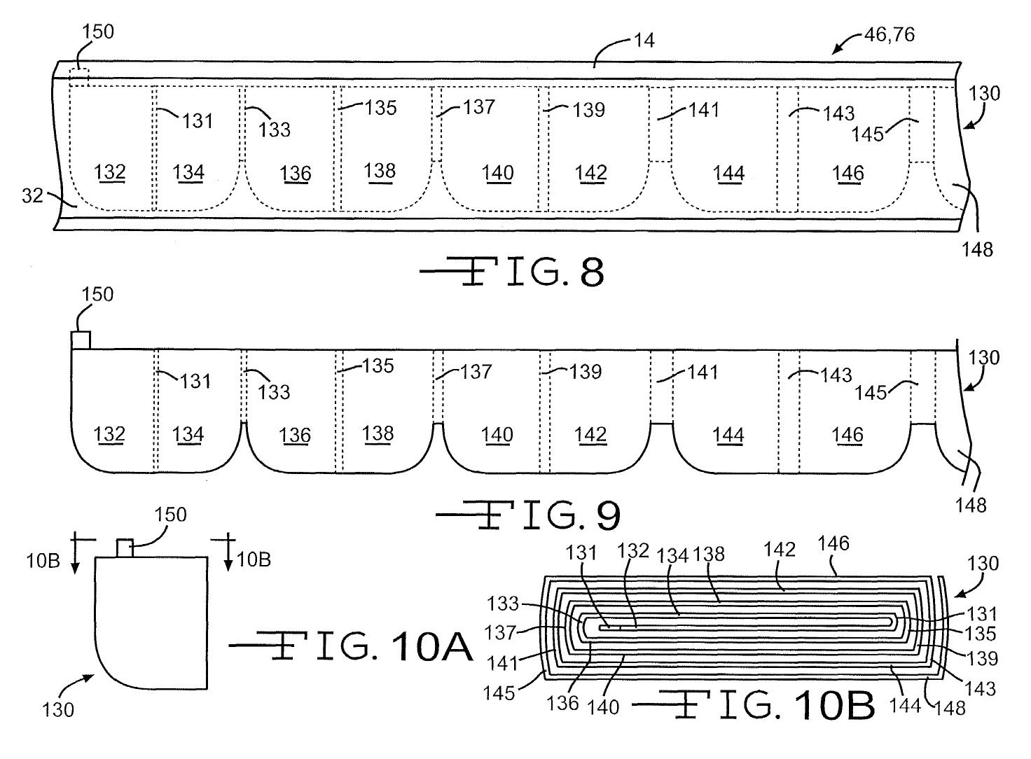

By way of example, FIG. 8 is an illustration of a portion of an elongated cathode sheet depicting a cutout pattern (dotted lines) for one embodiment of a cell cathode 130. FIG. 9 is an illustration of the cell cathode made from the cutout pattern of FIG. 8, but prior to winding it into a jellyroll configuration. In particular, individual electrode plates 132, 134, 136, 138, 140, 142, 144, 146 and 148 are arrayed sequentially, interspersed with fold sections 131, 133, 135, 137, 139, 141, 143 and 145. Contact tab 150 is provided extending upwardly from plate 132, although it may extend from other plates or fold sections.

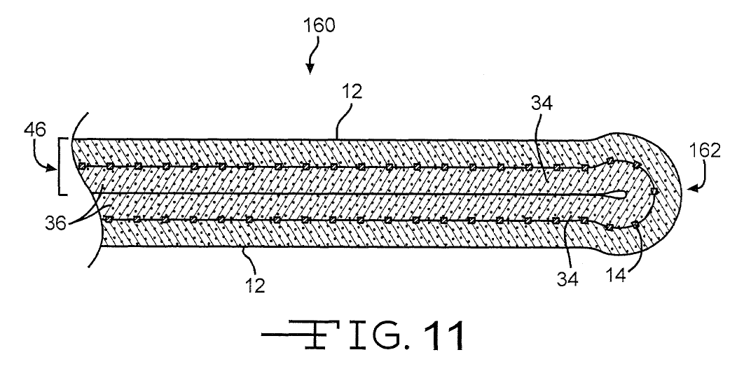

Referring also to FIGS. 10A and 10B, which are side elevation and top views of the electrode 130 after winding into a jellyroll configuration, cathode plate 132 is the innermost cathode plate. To account for the increasing wrap perimeter as the winding progresses from the inside to the outside of the jellyroll, each cathode plate 134, 136, 138, 140, 142, 144, 146 and 148 and each fold section 131, 133, 135, 137, 139, 141, 143 and 145 increases slightly in width in the direction from inside to outside (left to right in FIGS. 8 and 9).

In a further embodiment, a more complex cathode may be fabricated from the elongated cathode sheet 46 of FIGS. 3 and 5 to 7. FIG. 11 is a side cross-sectional view of a multi-layer cathode comprising first and second cathode active materials. Cathode 160 is formed by folding cathode sheet 46 over onto itself to form a sandwich cathode with the second electrode active material 34 facing inwardly and the first electrode active material 12 facing outwardly.

In fabricating elongated cathode sheet 46 for use in making cathode 160, the thickness of the cathode tapes 12 and 36 may be made thinner in the fold region 162, or they may be compressed to a lesser degree in the fold region 162, in order to reduce the possibility of cracking and/or delamination of the cathode tapes 12 and 36 from the current collector screen 14 there.

When a cathode electrode sheet material of the configuration: SVO/current collector/CFₓ is prepared and folded over onto itself on the CFₓ side, a sandwich cathode having the configuration SVO/current collector/CFₓ/current collector/SVO is prepared in a highly efficient manner. Therefore, one exemplary cathode assembly has the following configuration:

SVO/current collector/CFₓ, wherein the anode is of lithium and the SVO faces the anode.

In another embodiment, the cathode assembly has the following configuration:

SVO/current collector/CFₓ/current collector/SVO.

An important aspect of the present invention is that the high rate cathode material (in this case the SVO material) maintains direct contact with the current collector. Another embodiment of the present invention has the high capacity/low rate material sandwiched between the high rate cathode material, in which the low rate/high capacity material is in direct contact with the high rate material. This cathode design has the following configuration:

SVO/current collector/SVO/CFₓ/SVO/current collector/SVO.

Another important aspect of the present invention is that the higher capacity material having the lower rate capability is preferably positioned between two layers of higher rate cathode material. In other words, the exemplary CFₓ material never directly faces the lithium anode. In addition, the lower rate cathode material must be short circuited with the higher rate material, either by direct contact as demonstrated above in the second embodiment, or by parallel-connection through the current collectors as in the first illustrated embodiment above.

In order to prevent internal short circuit conditions, the cathode is separated from the anode by a suitable separator material. The separator is of electrically insulative material, and the separator material also is chemically unreactive with the anode and cathode active materials and both chemically unreactive with and insoluble in the electrolyte. In addition, the separator material has a degree of porosity sufficient to allow flow there through of the electrolyte during the electrochemical reaction of the cell. Illustrative separator materials include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C. H. Dexter, Div., Dexter Corp.), and a membrane commercially available under the designation TONEN®.

The electrochemical cell further includes a nonaqueous, ionically conductive electrolyte which serves as a medium for migration of ions between the anode and the cathode electrodes during electrochemical reactions of the cell. The electrochemical reaction at the electrodes involves conversion of ions in atomic or molecular forms which migrate from the anode to the cathode. Thus, nonaqueous electrolytes suitable for the present invention are substantially inert to the anode and cathode materials, and they exhibit those physical properties necessary for ionic transport, namely, low viscosity, low surface tension and wettability.

A suitable electrolyte has an inorganic, ionically conductive salt dissolved in a nonaqueous solvent, and more preferably, an ionizable lithium salt dissolved in a mixture of aprotic organic solvents comprising a low viscosity solvent and a high permittivity solvent. The inorganic, ionically conductive salt serves as the vehicle for migration of the anode ions to intercalate or react with the cathode active materials. Preferred lithium salts include LiPF₆, LiBF₄, LiAsF₆, LiSbF₆, LiClO₄, LiO2, LiAlCl₄, LiGaCl₄, LiC(SO₂CF₃)₃, LiN(SO₂CF₃)₂, LiSCN, LiO₃SCF₃, LiC₆FSO₃, LiO₂CCF₃, LiSO₆F, LiB(C₆H₅)₄, LiCF₃SO₃, and mixtures thereof.

Low viscosity solvents include esters, linear and cyclic ethers and dialkyl carbonates such as tetrahydrofuran (THF), methyl acetate (MA), diglyme, triglyme, tetraglyme, dimethyl carbonate (DMC), 1,2-dimethoxyethane (DME), 1,2-diethoxyethane (DEE), 1-ethoxy, 2-methoxyethane (EME), ethyl methyl carbonate, methyl propyl carbonate, ethyl propyl carbonate, diethyl carbonate, dipropyl carbonate, and mixtures thereof, and high permittivity solvents include cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, γ-butyrolactone (GBL), N-methyl-pyrrolidinone (NMP), and mixtures thereof. For a primary cell, the preferred anode is lithium metal and the preferred electrolyte is 0.8M to 1.5M LiAsF₆ or LiPF₆ dissolved in a 50:50 mixture, by volume, of propylene carbonate as the preferred high permittivity solvent and 1,2-dimethoxyethane as the preferred low viscosity solvent.

The assembly of the cells described herein is preferably in the form of a wound element configuration. That is, the fabricated negative electrode, positive electrode and separator are wound together in a “jellyroll” type configuration or “wound element cell stack” such that the negative electrode is on the outside of the roll to make electrical contact with the cell case in a case-negative configuration. Using suitable top and bottom insulators, the wound cell stack is inserted into a metallic case of a suitable size dimension. The metallic case may comprise materials such as stainless steel, mild steel, nickel-plated mild steel, titanium, tantalum or aluminum, but not limited thereto, so long as the metallic material is compatible for use with the other cell components.

The cell header comprises a metallic disc-shaped body with a first hole to accommodate a glass-to-metal seal/terminal pin feedthrough and a second hole for electrolyte filling. The glass used is of a corrosion resistant type having up to about 50% by weight silicon such as CABAL 12, TA 23, FUSITE 425 or FUSITE 435. The positive terminal pin feedthrough preferably comprises titanium although molybdenum, aluminum, nickel alloy, or stainless steel can also be used. The cell header is typically of a material similar to that of the case. The positive terminal pin supported in the glass-to-metal seal is, in turn, supported by the header, which is welded to the case containing the electrode stack. The cell is thereafter filled with the electrolyte solution described hereinabove and hermetically sealed such as by close-welding a stainless steel ball over the fill hole, but not limited thereto.

The above assembly describes a case-negative cell, which is the preferred construction of the exemplary primary and secondary cells of the present invention. As is well known to those skilled in the art, the primary and secondary electrochemical systems can also be constructed in case-positive configuration.

It is, therefore, apparent that there has been provided, in accordance with the present invention, an electrochemical cell including a sandwich cathode, and methods for making the cell and cathode. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

1-13. (canceled)

14. A method for manufacturing an electrode for an electrochemical cell, comprising the steps of:
a) delivering a current collector strip through a tape contacting station;
b) contacting a first tape of a first electrode active material to a first side of the current collector;
c) contacting a second tape of a second electrode active material to a second side of the current collector to form a coated electrode strip;
d) cutting a section of the coated electrode strip to form an electrode sheet; and
e) folding the electrode sheet onto itself to form a sandwich electrode with the second electrode active material facing inwardly and the first electrode active material facing outwardly.

15. The method of claim 14 further comprising the step of cutting the sandwich electrode into a pattern of matched electrode plate units.

16. The method of claim 14 further comprising the steps of compressing the first tape of the first electrode active material onto the first side of the current collector and compressing the second tape of the second electrode active material onto the second side of the current collector.

17. The method of claim 16 including simultaneously compressing the first and second tapes of the respective electrode active materials onto the current collector.

18. The method of claim 17 including compressing the first and second tapes of the respective electrode active materials using a pair of opposed rollers.

19. The method of claim 15 including preforming the first and second tapes of the respective electrode active materials prior to contacting them to the current collector.

20. The method of claim 15 including forming the first and second tapes from dispensed pastes of the respective electrode active materials.

21. The method of claim 15 including providing the first electrode active material of a first energy density and a first rate capability and the second electrode active material of a second energy density and a second rate capability, the first energy density of the first electrode active material being less than the second energy density of the second electrode active material while the first rate capability of the first electrode active material is greater than the second rate capability of the second electrode active material.

22. The method of claim 21 including providing the first electrode active material being SVO and the second electrode active material being CFₓ.

23. A method for providing an electrochemical cell, comprising the steps of:
a) providing an anode;
b) providing a cathode including the steps of:
i) delivering a current collector strip through a tape contacting station;
ii) contacting a first tape of a first cathode active material to a first side of the current collector strip;
iii) contacting a second tape of a second cathode active material to a second side of the current collector strip to form a coated cathode strip;
iv) cutting a section of the coated cathode strip to form a cathode sheet; and
v) folding the cathode sheet onto itself to form a sandwich cathode with the second cathode active material facing inwardly and the first cathode active material facing outwardly;
c) positioning a separator between the anode and the cathode to physically segregate them from each other as an electrode assembly;
d) housing the electrode assembly in a casing; and
c) activating the anode and the cathode housed inside the casing with an electrolyte.

24. The method of claim 23 further comprising the step of cutting the sandwich cathode into a pattern of matched cathode plate units.

25. The method of claim 23 including providing the first cathode active material of a first energy density and a first rate capability and the second cathode active material of a second energy density and a second rate capability, the first energy density of the first cathode active material being less than the second energy density of the second cathode active material while the first rate capability of the first cathode active material is greater than the second rate capability of the second cathode active material.

26. The method of claim 24 including providing the first cathode active material being SVO and the second cathode active material being CFₓ.
